(19) United States
(12) Patent Application Publication
(10) Pub. No.: US 2006/0043771 A1
(43) Pub. Date: Mar. 2, 2006

(54) One-piece sidewall liner with logistic slot and method of making same

(76) Inventor: Rodney P. Ehrlich, Monticello, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/925,609

(22) Filed: Aug. 25, 2004

(51) Int. Cl. B62D 33/023

(52) U.S. Cl. 296/186.1

(57) ABSTRACT

A sidewall for a trailer and a method of forming same is provided. The sidewall includes a frame having a top rail, a bottom rail and a plurality of posts extending between the top rail and the bottom rail. Each post has a plurality of slots provided therethrough. The sidewall further includes an inner wall which is formed of a one-piece continuous liner secured to the plurality of posts. The one-piece continuous liner has a plurality of slots provided therethrough which are in communication with the plurality of slots provided through the posts. Equipment can be engaged with the slots. The inner wall may also have a scuff plate attached thereto at a bottom thereof in order to protect the inner wall.

### BACKGROUND OF THE INVENTION

The present invention relates to a sidewall construction for a trailer and a method of forming same. More specifically, the present invention relates to an inner wall of a sidewall construction for a trailer which is formed of a one-piece continuous liner secured to posts of the trailer, where the posts and the one-piece continuous liner both have slots therethrough for enabling engagement of equipment to the sidewall of the trailer, as well as the method of forming same.

Trailers are formed to have sidewalls which are both strong, in order to withstand the abuse put on them, for instance by forklifts banging in to them, as well as lightweight such that more cargo can be stored within the trailer as there are weight restrictions on trailers when they travel across certain roads and highways. The construction and method of forming these sidewalls, though, are often complex. Also, such constructions and methods do not generally provide means for allowing the engagement of equipment, which can be very beneficial during the transportation of cargo within the trailer.

Thus, there is a need for a sidewall construction for a trailer which overcomes the aforementioned disadvantages. The present invention provides such a sidewall construction for a trailer. Features and advantages of the present invention will become apparent upon a reading of the attached specification, in combination with a study of the drawings.

### OBJECTS AND SUMMARY OF THE INVENTION

A primary object of the invention is to provide an inner wall of a sidewall of a trailer which is formed of a one-piece continuous liner secured to posts of the trailer, where the posts and the one-piece continuous liner both have slots therethrough for enabling engagement of equipment to the sidewall of the trailer, as well as the method of forming same.

An object of the invention is to provide an inner wall of a sidewall of a trailer which is relatively lightweight and inexpensive to manufacture.

Another object of the invention is to provide an inner wall of a sidewall of a trailer formed of a one-piece continuous liner which, in one embodiment, is seamless as the liner is secured to posts of the trailer by an adhesive.

Another object of the invention is to provide an inner wall of a sidewall of a trailer formed of a one-piece continuous liner which, in one embodiment, is secured to posts of the trailer by a plurality of rivets.

Yet another object of the invention is to provide an inner wall of a sidewall of a trailer formed of a one-piece continuous liner which, in one embodiment is secured to posts of the trailer by both an adhesive and by a plurality of rivets.

Briefly, and in accordance with the foregoing, the invention provides a sidewall for a trailer and a method of forming same. The sidewall includes a frame having a top rail, a bottom rail and a plurality of posts extending between the top rail and the bottom rail. Each post has a plurality of slots provided therethrough. The sidewall further includes an inner wall which is formed of a one-piece continuous liner secured to the plurality of posts. The one-piece continuous liner has a plurality of slots provided therethrough which are in communication with the plurality of slots provided through the posts. Equipment can be engaged with the slots. The inner wall may also have a scuff plate attached thereto at a bottom thereof in order to protect the inner wall.

### BRIEF DESCRIPTION OF THE DRAWINGS

The features of the invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a perspective view of a trailer which incorporates the features of the invention with the trailer connected to a tractor;

FIG. 2 is a partially cut-away perspective view of the trailer equipped with the one-piece sidewall liner with logistic slot which incorporates features of the present invention;

FIG. 3 is a perspective view of a frame of a sidewall of the trailer illustrated in FIG. 2, which is used in forming an inner wall of the sidewall, illustrating a preferred embodiment of the posts of the frame;

FIG. 4 is a perspective view of a frame of a sidewall of the trailer illustrated in FIG. 2, illustrating two alternative embodiments of the posts of the frame;

FIG. 5 is a cross-sectional view of the first alternative embodiment of the posts of the frame illustrated in FIG. 4;

FIG. 6 is a cross-sectional view of the second alternative embodiment of the posts of the frame illustrated in FIG. 4;

FIG. 7 is a perspective view of a pre-configured punching die used in the method of forming the inner wall of the sidewall;

FIGS. 8-14 illustrate a first embodiment of a method for forming the inner wall of the sidewall;

FIG. 8 is a flow chart of the first embodiment of the method;

FIG. 9 is a perspective view of the one-piece continuous liner being secured to the frame by an adhesive;

FIG. 9A is a perspective view of a plurality of continuous liners being secured to the frame by an adhesive;

FIG. 10 is an enlarged, partially cut-away perspective view of the one-piece continuous liner being secured to the frame by an adhesive;

FIG. 11 is a perspective view of the pre-configured punching die punching slots through the one-piece continuous liner which is secured to the frame by the adhesive;

FIG. 12 is a perspective view of the one-piece continuous liner being secured to the frame by the adhesive and having the slots punched therethrough;

FIG. 13 is a perspective view of the one-piece continuous liner being secured to the frame by the adhesive and having the slots punched therethrough, and having a scuff plate secured to a bottom end of the one-piece continuous liner by an adhesive;

FIG. 14 is an enlarged, partially cut-away perspective view of the scuff plate being secured to a bottom end of the one-piece continuous liner by an adhesive;

FIGS. 15-18 illustrate a second embodiment of a method for forming the inner wall of the sidewall;

FIG. 15 is a flow chart of the second embodiment of the method;

FIG. 16 is a perspective view of the one-piece continuous liner being secured to the frame by a plurality of rivets;

FIG. 17 is a cross-sectional view of the one-piece continuous liner being secured to the frame by a plurality of rivets;

FIG. 18 is a perspective view of the one-piece continuous liner being secured to the frame by a plurality of rivets and having the slots punched therethrough;

FIGS. 19 and 20 illustrate a third embodiment of a method for forming the inner wall of the sidewall;

FIG. 19 is a flow chart of the third embodiment of the method;

FIG. 20 is a perspective view of the one-piece continuous liner being secured to the frame by rivets and by adhesive, and having the slots punched therethrough;

FIGS. 21-24 illustrate a fourth embodiment of a method for forming the inner wall of the sidewall;

FIG. 21 is a flow chart of the fourth embodiment of the method;

FIG. 22 is a perspective view of the one-piece continuous liner having the slots punched therethrough and having apertures provided proximate to the top end thereof;

FIG. 23 is a perspective view of the one-piece continuous liner having the slots punched therethrough and having the apertures provided therethrough proximate to the top end thereof and being secured to the frame by adhesive such that the bottom end of the one-piece continuous liner does not abut against the bottom rail;

FIG. 23A is a perspective view of an alternative construction of the one-piece continuous liner which has the slots punched therethrough and having the apertures provided therethrough proximate to the top end thereof and being secured to the frame by adhesive such that the bottom end of the one-piece continuous liner abuts against the bottom rail;

FIG. 24 is a perspective view of a scuff plate being adhered to the one-piece continuous liner illustrated in FIG. 23;

FIGS. 25 and 26 illustrate a fifth embodiment of a method for forming the inner wall of the sidewall;

FIG. 25 is a flow chart of the fifth embodiment of the method;

FIG. 26 is a perspective view of the one-piece continuous liner being secured to the frame by a plurality of rivets and having the slots punched therethrough;

FIG. 27 is a flow chart of the sixth embodiment of the method;

FIG. 28 is a perspective view of an outer wall of the sidewall configuration of the present invention; and

FIG. 29 is a perspective view of the frame of the sidewall of the trailer illustrated in FIG. 3, having insulative material provided between the posts of the frame.

### DETAILED DESCRIPTION OF THE ILLUSTRATED EMBODIMENTS

While this invention may be susceptible to embodiment in different forms, there is shown in the drawings and will be described herein in detail, specific embodiments with the understanding that the present disclosure is to be considered an exemplification of the principles of the invention, and is not intended to limit the invention to that as illustrated.

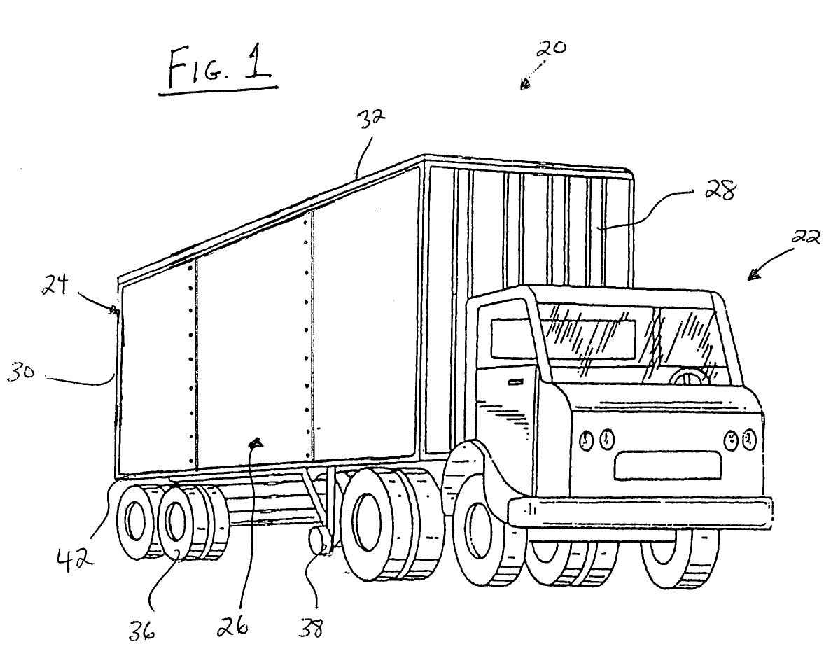

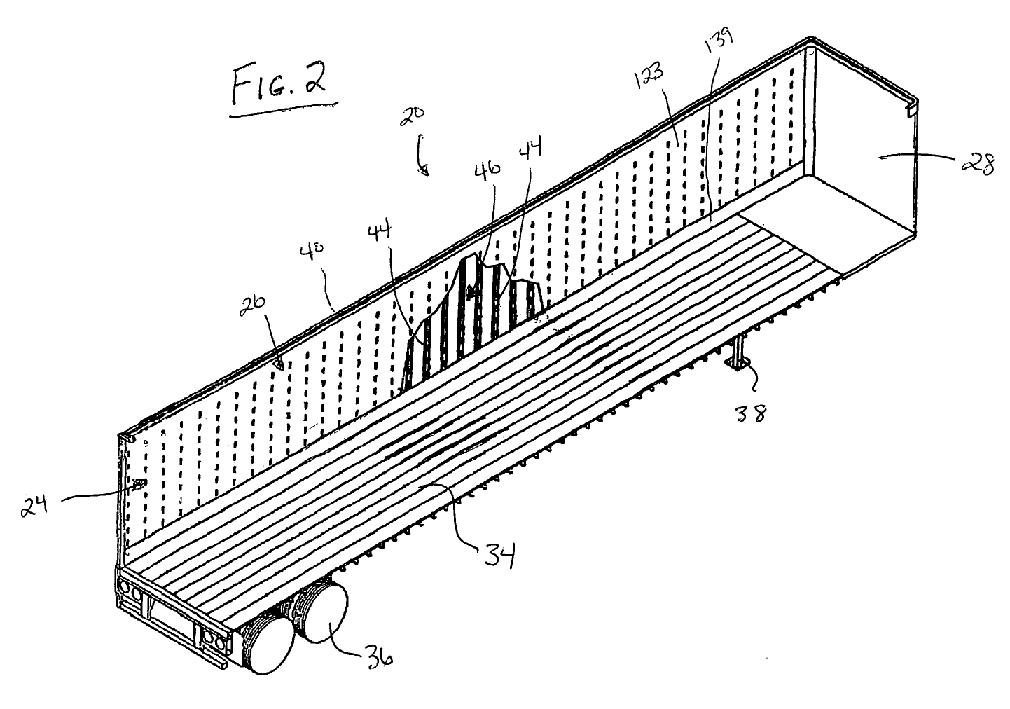

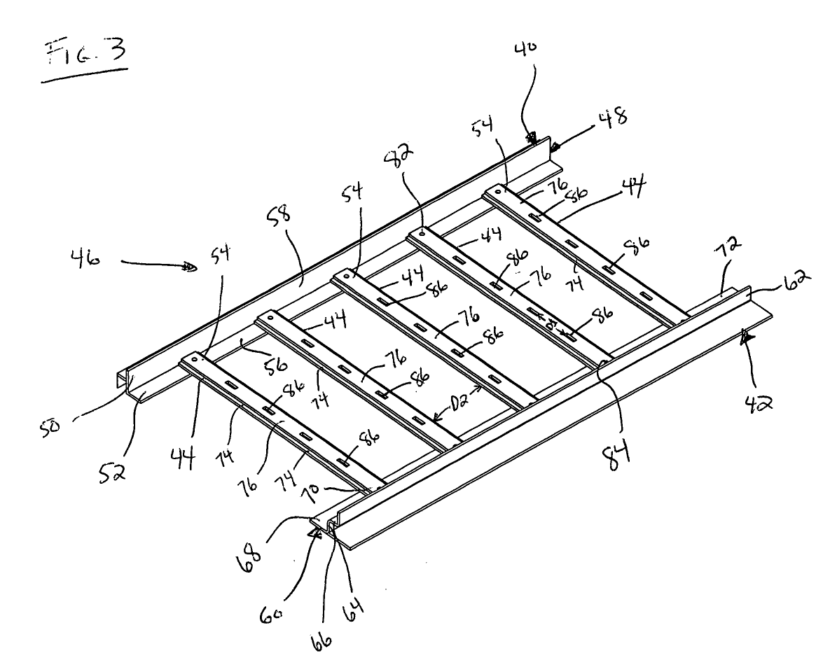

A trailer 20 having a pair of sidewalls 26 constructed in accordance with the present invention is shown in FIGS. 1-3. The trailer 20 of FIG. 1 is shown connected to a tractor 22 by conventional means, such as a fifth wheel assembly. The trailer 20 includes a body 24 formed from the pair of rectangular sidewalls 26, a front wall 28, rear doors 30, a top panel or roof 32, and a floor 34. The floor 34 is supported by a conventional rear undercarriage assembly 36 and has a landing gear 38 secured thereunder. The top panel 32 and an upper portion of the sidewalls 26 are secured to a top rail 40, and the floor 34 and lower portion of the sidewalls 26 are secured to a bottom rail 42. A plurality of posts 44 connect the top rail 40 to the bottom rail 42. The top rail 40, the bottom rail 42, and the plurality of posts 44 comprise a frame 46 of the sidewall 26, as illustrated in FIG. 3.

The top rail 40 includes an L-shaped member 48 having a first horizontal flat portion 50 and a second vertical flat portion 52 which is generally perpendicular to the first portion 50. The top panel or roof 32 is attached to a top surface (not shown) of the first portion 50. Top ends 54 of the plurality of posts 44 are attached to an inner surface 56 of the second portion 52 and are positioned proximate to, and preferably abut against, a bottom surface 58 of the first portion 50.

The bottom rail 42 includes a member 60 having a first horizontal flat portion 62, a second vertical flat portion 64, a third horizontal flat portion 66, and a fourth vertical flat portion 68. The first portion 62 is perpendicular to the second portion 64; the second portion 64 is perpendicular to the third portion 66; and the third portion 66 is perpendicular to the fourth portion 68. The first portion 62 is parallel to the third portion 66 and the second portion 64 is parallel to the fourth portion 68. The floor 34 is attached to a top surface (not shown) of the first portion 62. Bottom ends 70 of the plurality of posts 44 are attached to an inner surface 72 of the fourth portion 68 and are positioned proximate to, and preferably abut against, a top surface (not shown) of the third portion 66.

Each post 44 as explained above has a top end 54 and a bottom end 70, and is preferably formed from a strong metal. Each post 44 is preferably formed to have flat end portions 74 and an intermediate portion 76 which bulges inwardly from the flat end portions 74 such that the post 44 is generally U-shaped. Each post 44 also has inner and outer surfaces 78, 80. The top end 54 of each post 44 is positioned against the top rail 40 such that the outer surface 80 of each flat end portion 74 is positioned against the inner surface 56 of the second portion 52 of the top rail 40, and such that the top end 54 of each post 44 is positioned proximate to, and preferably abuts against, the bottom surface 58 of the first portion 50. The bottom end 70 of each post 44 is positioned against the bottom rail 42 such that the outer surface 80 of each flat end portion 74 is positioned against the inner surface 72 of the fourth portion 68 of the bottom rail 42, and such that the bottom end 70 of each post 44 is positioned proximate to, and preferably abuts against, the top surface (not shown) of the third portion 66. Each post 44 is secured to the top and bottom rails 40, 42 by known means, such as by fasteners, for instance rivets, or by adhesive, or both.

Each post 44 has an aperture 82 provided through the intermediate portion 76 thereof proximate to the top end 54 thereof. Each post 44 has an aperture 84 provided through the intermediate portion 76 thereof proximate to the bottom end 70 thereof. The purpose for the apertures 82, 84 being provided through the intermediate portion 76 of each post 44 will be discussed in further detail hereinbelow.

In addition, each post 44 has a plurality of spaced-apart openings or slots 86 therethrough along a length of the intermediate portion 76 thereof, with each of the slots 86 preferably being positioned between the aperture 82 and the aperture 84. Each slot 86 is preferably distanced from an adjacent slot 86 by a predetermined distance D1. The predetermined distance D1 may vary depending on the construction of the trailer 20, but generally equates to twelve (12) inches. Of course, it is to be understood that each post 44 may be outfitted with as many slots 86 as desired, and the positioning of each slot 86 relative to an adjacent slot 86 need not be a predetermined uniform distance.

Each post 44 is preferably distanced from an adjacent post 44 by a predetermined distance D2. The predetermined distance D2 may vary depending on the construction of the trailer 20, but generally equates to twelve (12), sixteen (16) or twenty-four (24) inches. Of course, it is to be understood that the positioning of each post 44 relative to an adjacent post 44 need not be a predetermined uniform distance.

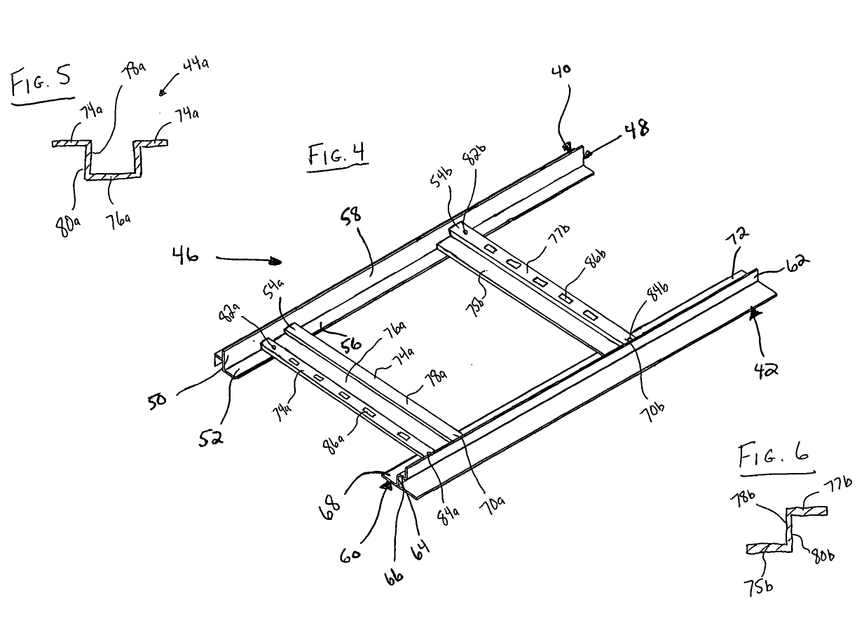

While the configuration of the posts 44 as described hereinabove and as best illustrated in FIG. 3 is the preferred embodiment of the posts, the posts can also be configured in any other suitable manner, such as those illustrated in FIGS. 4-6.

FIGS. 4 and 5 illustrate a first alternative configuration of the post 44, which is denoted by reference numeral 44a. Post 44a has a top end 54a and a bottom end 70a, and is preferably formed from a strong metal. Each post 44a is preferably formed to have flat end portions 74a and an intermediate portion 76a which bulges outwardly from the flat end portions 74a, such that the post 44a is generally U-shaped. Each post 44a also has inner and outer surfaces 78a, 80a. The top end 54a of each post 44a is positioned against the top rail 40 such that the outer surface 80a of the intermediate portion 76a is positioned against the inner surface 56 of the second portion 52 of the top rail 40, and such that the top end 54 of each post 44a is positioned proximate to, and preferably abuts against, the bottom surface 58 of the first portion 50. The bottom end 70 of each post 44a is positioned against the bottom rail 42 such that the outer surface 80a of the intermediate portion 76a is positioned against the inner surface 72 of the fourth portion 68 of the bottom rail 42, and such that the bottom end 70 of each post 44a is positioned proximate to, and preferably abuts against, the top surface (not shown) of the third portion 66. Each post 44a is secured to the top and bottom rails 40, 42 by known means, such as by fasteners, for instance rivets, or by adhesive, or both.

Each post 44a has an aperture 82a provided through at least one of the flat end portions 74a thereof proximate to the top end 54a thereof. Each post 44a has an aperture 84a provided through at least one of the flat end portions 74a thereof proximate to the bottom end 70a thereof. The purpose for the apertures 82a, 84a being provided through the at least one of the flat end portions 74a of each post 44a will be discussed in further detail hereinbelow.

In addition, each post 44a has a plurality of spaced-apart openings or slots 86a therethrough along a length of at least one of the flat end portions 74a thereof, with each of the slots 86a preferably being positioned between the aperture 82a and the aperture 84a. The distance between each slot 86a is preferably identical to the distance between each slot 86 and the distance between adjacent posts 44a is preferably identical to the distance between adjacent posts 44.

FIGS. 4 and 6 illustrate a second alternative configuration of the post 44, which is denoted by reference numeral 44b. Post 44b has a top end 54b and a bottom end 70b, and is preferably formed from a strong metal. Each post 44b is preferably formed to have a first flat end portion 75b and a second flat end portion 77b, which are connected to one another, but which are not in the same plane, such that the post 44b is generally Z-shaped. Each post 44b also has inner and outer surfaces 78b, 80b. The top end 54b of each post 44b is positioned against the top rail 40 such that the outer surface 80b of the first flat end portion 75b is positioned against the inner surface 56 of the second portion 52 of the top rail 40, and such that the top end 54 of each post 44b is positioned proximate to, and preferably abuts against, the bottom surface 58 of the first portion 50. The bottom end 70 of each post 44b is positioned against the bottom rail 42 such that the outer surface 80b of the first flat end portion 75b is positioned against the inner surface 72 of the fourth portion 68 of the bottom rail 42, and such that the bottom end 70 of each post 44b is positioned proximate to, and preferably abuts against, the top surface (not shown) of the third portion 66. Each post 44b is secured to the top and bottom rails 40, 42 by known means, such as by fasteners, for instance rivets, or by adhesive, or both.

Each post 44b has an aperture 82b provided through the second flat end portion 77b thereof proximate to the top end 54b thereof. Each post 44b has an aperture 84b provided through the second flat end portion 77b thereof proximate to the bottom end 70b thereof. The purpose for the apertures 82b, 84b being provided through the second flat end portion 77b of each post 44b will be discussed in further detail hereinbelow.

In addition, each post 44b has a plurality of spaced-apart openings or slots 86b therethrough along a length of the second flat end portion 77b thereof, with each of the slots 86b preferably being positioned between the aperture 82b and the aperture 84b. The distance between each slot 86b is preferably identical to the distance between each slot 86 and the distance between adjacent posts 44b is preferably identical to the distance between adjacent posts 44.

While posts 44a and 44b have been described hereinabove and illustrated in FIGS. 4-6, further description of the invention will generally be made with reference to only post 44 as it is the preferred configuration for the post. It is to be understood that the posts 44a and 44b, as well as any other similar configuration of post, could be utilized instead of the post 44 in order to achieve the objects of the invention.

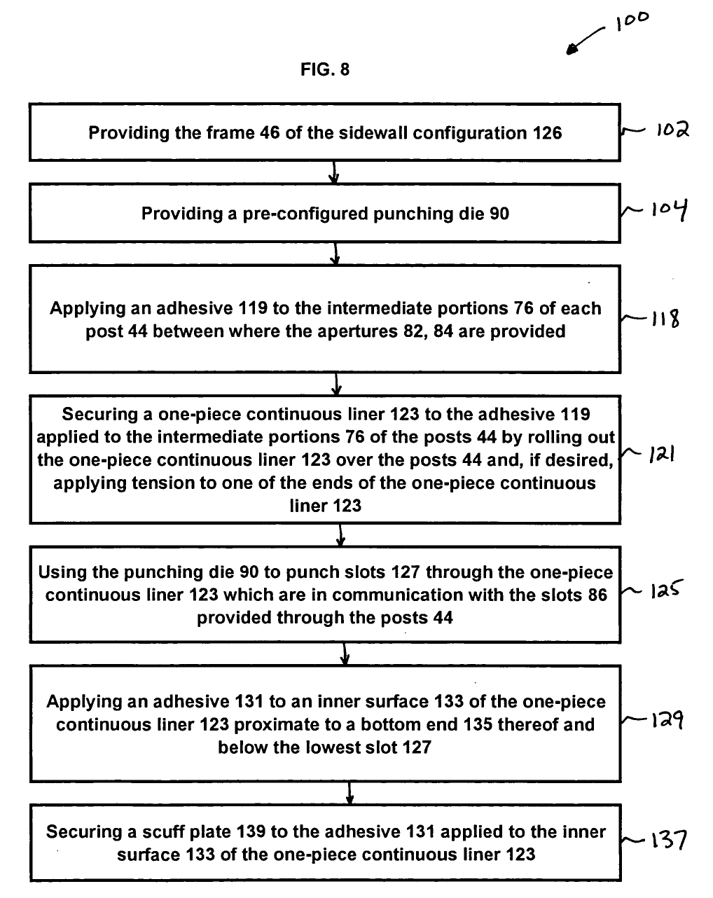

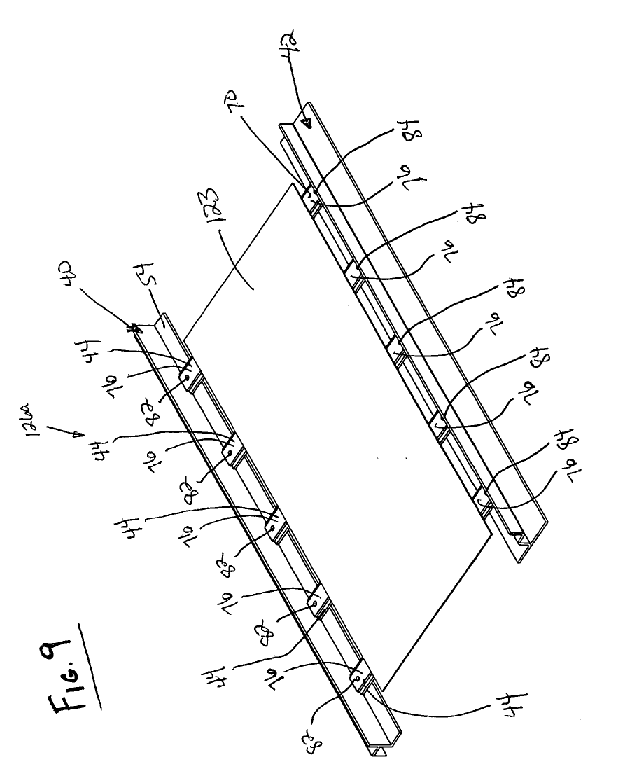

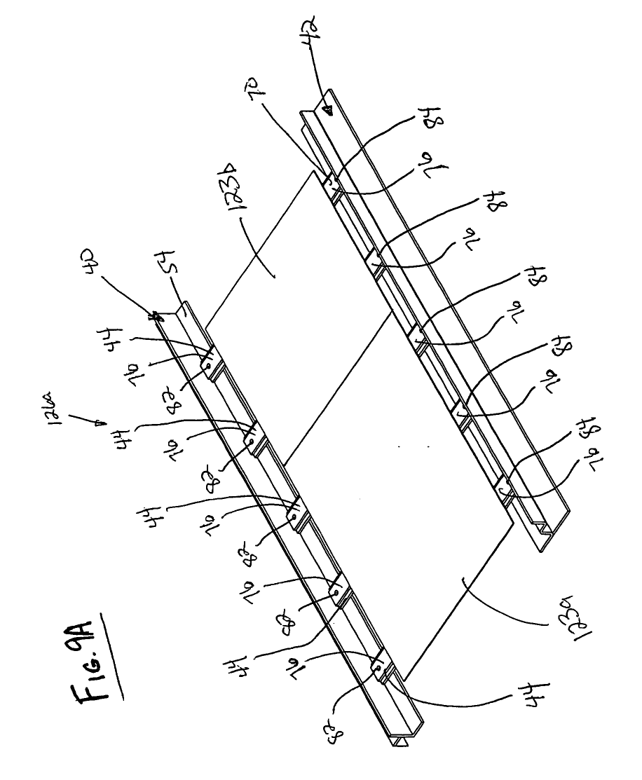

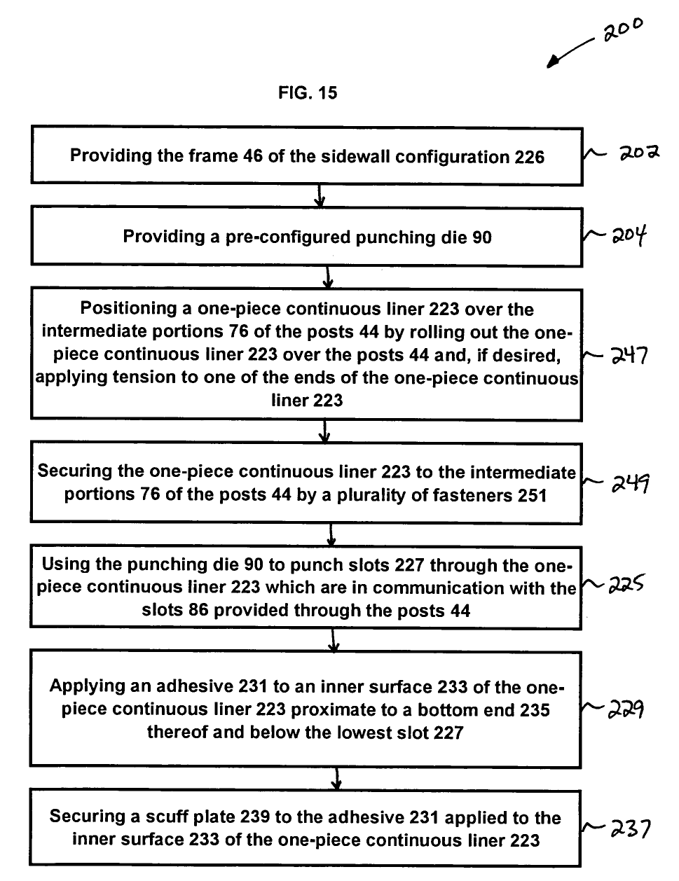

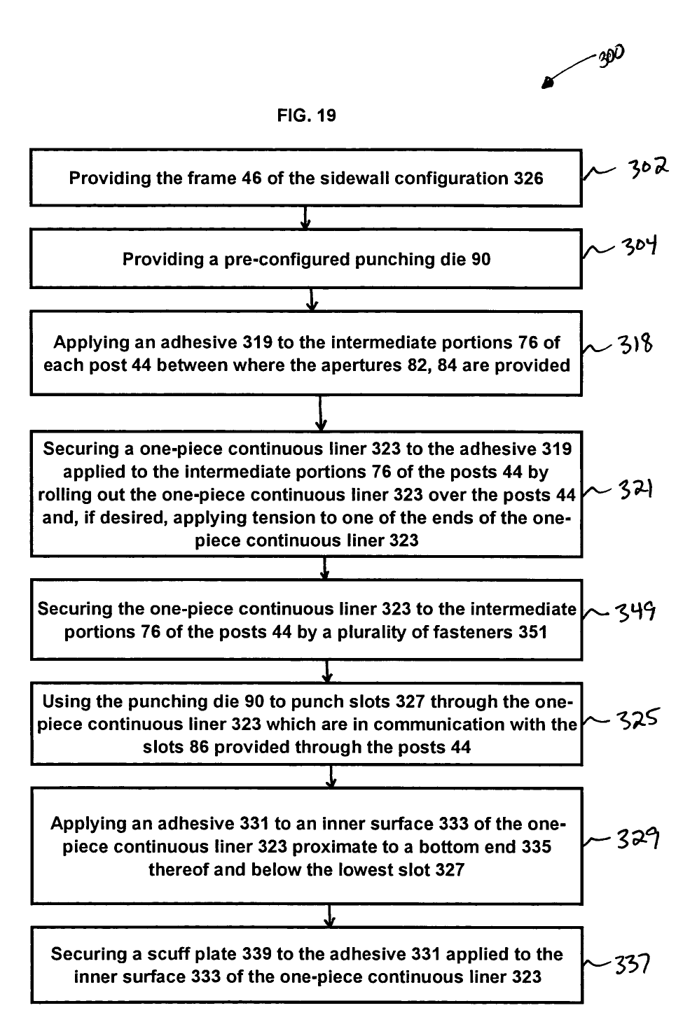

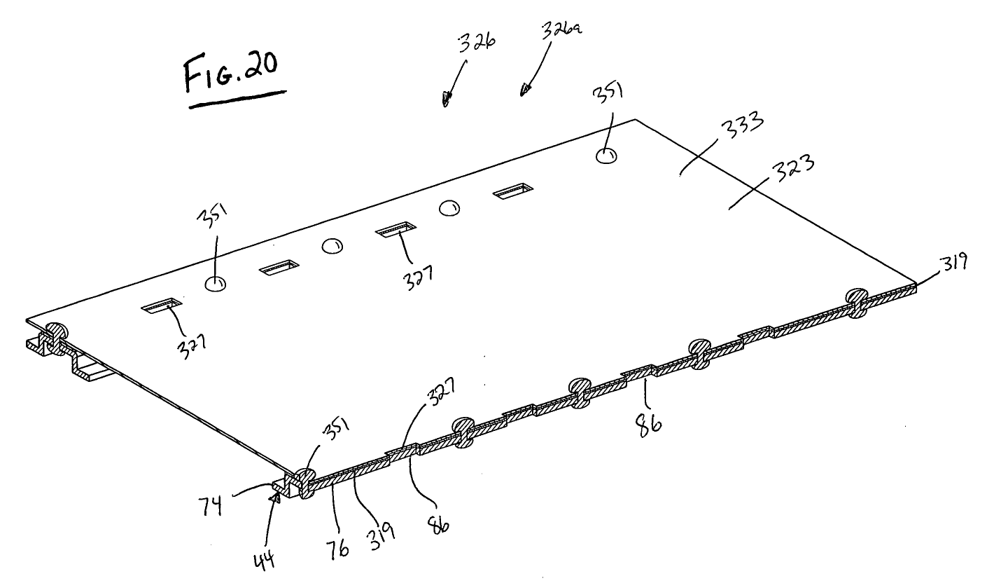

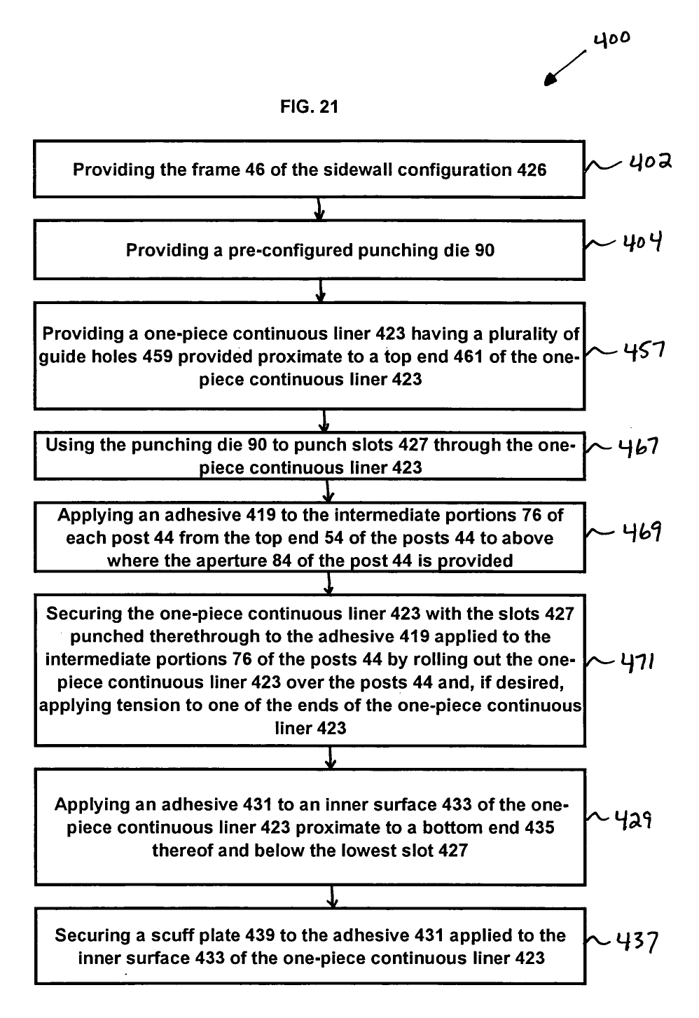

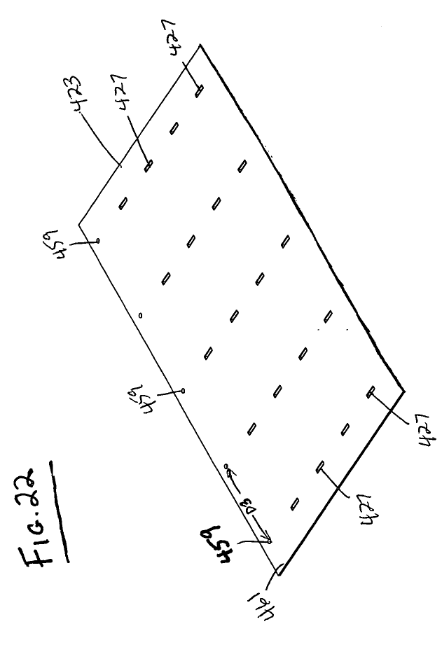

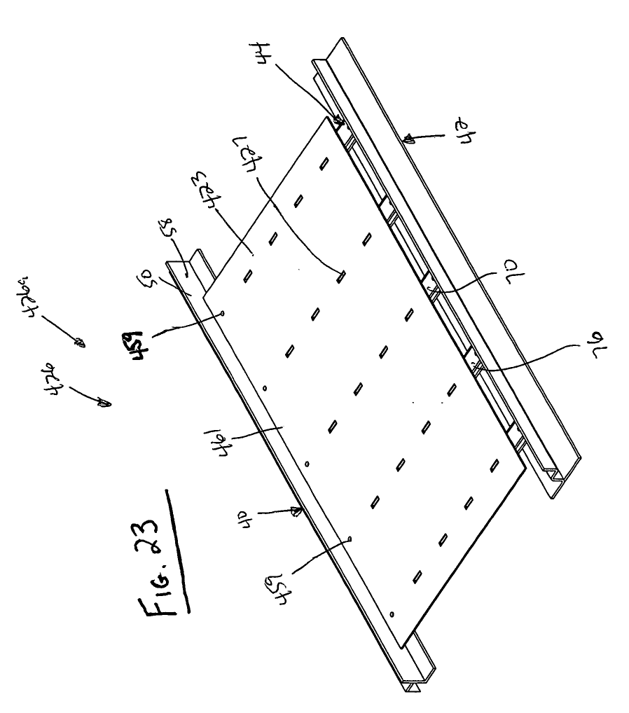

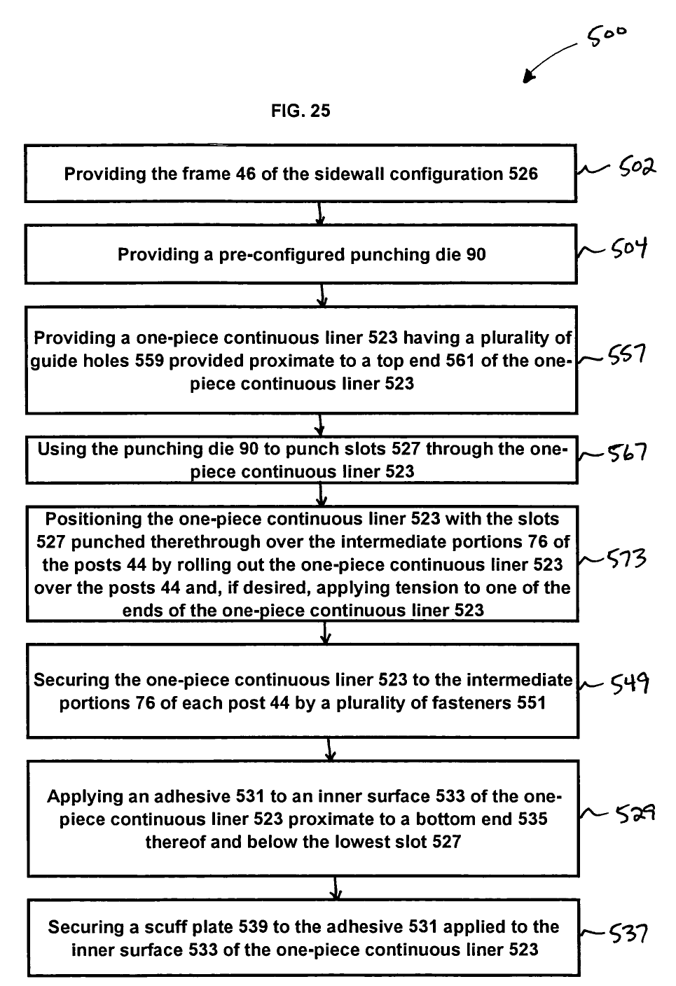

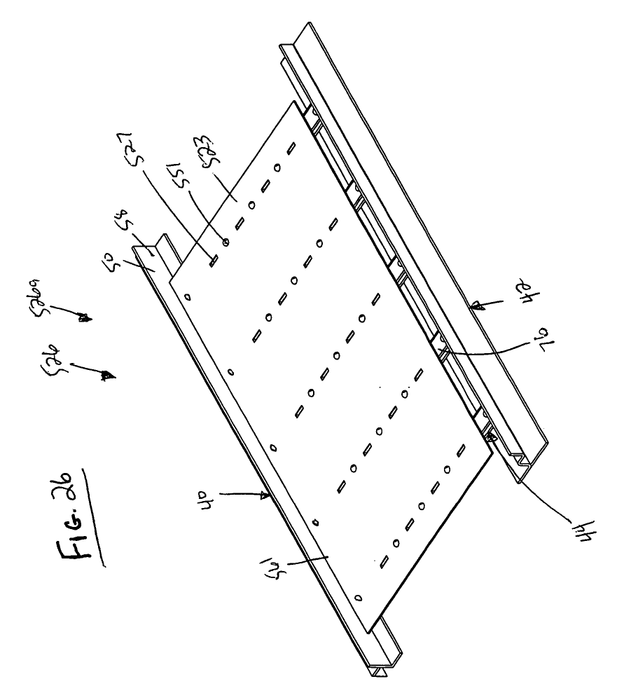

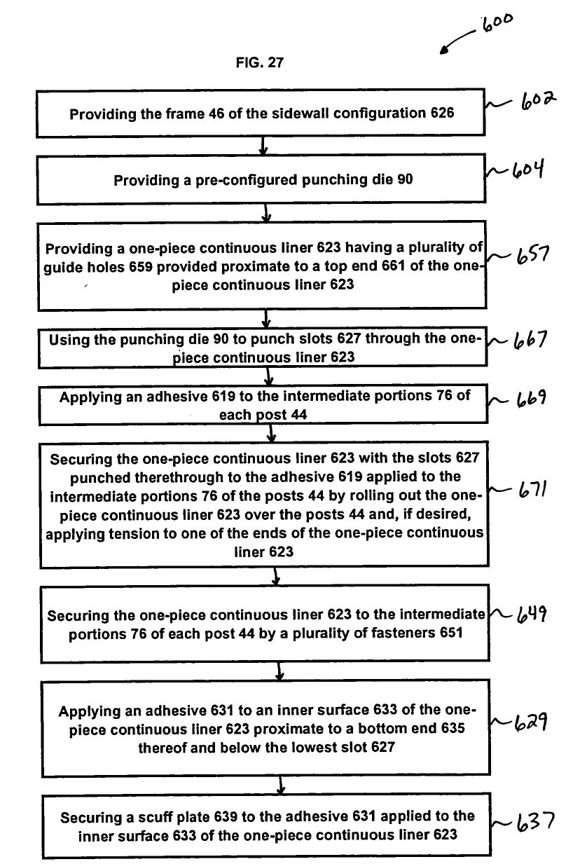

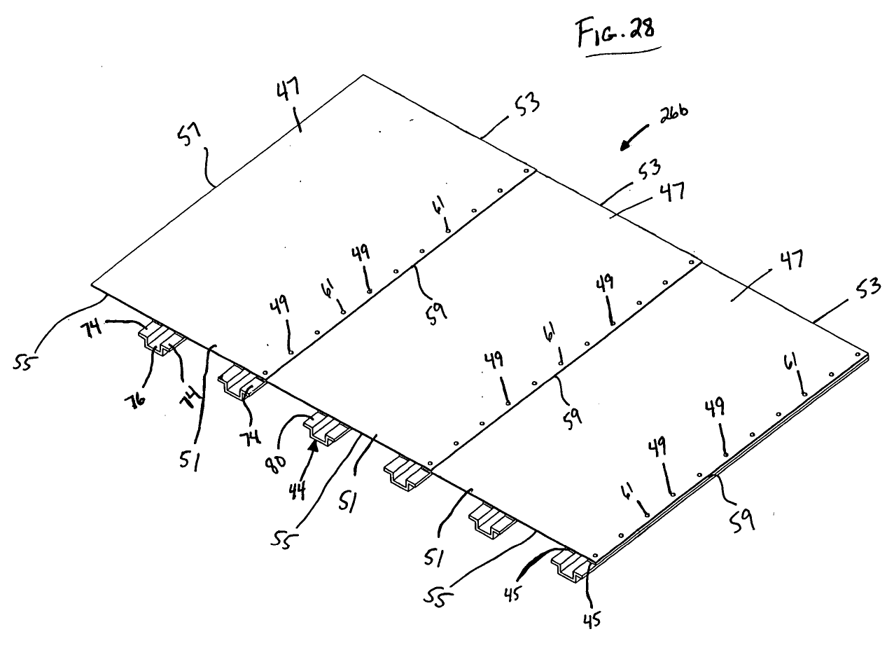

Attention is now directed to the various embodiments of the configuration of the inner wall 26a of the sidewall 26 and the methods of forming same, as illustrated in FIGS. 8-27. A first embodiment of the inner wall 126a of the sidewall configuration 126 and a method 100 of forming same is illustrated in FIGS. 8-14. A second embodiment of the inner wall 226a of the sidewall configuration 226 and a method 100 of forming same is illustrated in FIGS. 15-18. A third embodiment of the inner wall 326a of the sidewall configuration 326 and a method 300 of forming same is illustrated in FIGS. 19-20. A fourth embodiment of the inner wall 426a of the sidewall configuration 426 and a method 400 of forming same is illustrated in FIGS. 21-24. A fifth embodiment of the inner wall 526a of the sidewall configuration 526 and a method 500 of forming same is illustrated in FIGS. 25-26. A sixth embodiment of the inner wall 626a of the sidewall configuration 626 and a method 600 of forming same is illustrated in FIG. 27. Like elements are denoted with like reference numerals with the first embodiment of the inner wall 126a of the sidewall construction 126 and the method 100 of forming same being in the one hundreds, the second embodiment of the inner wall 226a of the sidewall construction 226 and the method 200 of forming same being in the two hundreds, the third embodiment of the inner wall 326a of the sidewall construction 326 and the method 300 of forming same being in the three hundreds, the fourth embodiment of the inner wall 426a of the sidewall construction 426 and the method 400 of forming same being in the four hundreds, the fifth embodiment of the inner wall 526a of the sidewall construction 526 and the method 500 of forming same being in the five hundreds, and the sixth embodiment of the inner wall 626a of the sidewall construction 626 and the method 600 of forming same being in the six hundreds. As shown in the drawings, only a portion of the inner wall 126a, 226a, 326a, 426a, 526a, 626a of the sidewall configurations 126, 226, 326, 426, 526, 626 is illustrated. It is to be understood that each inner wall 126a, 226a, 326a, 426a, 526a, 626a of the sidewall configuration 126, 226, 326, 426, 526, 626 illustrated is provided for each sidewall 26 between the front wall 28 and the rear doors 30.

Attention is directed to FIGS. 8-14 and the first embodiment of the inner wall 126a of the sidewall configuration 126 and the method 100 of forming same. A flow chart of the steps of the method 100 is illustrated in FIG. 8. Step 102 provides the frame 46 of the sidewall configuration 126, as illustrated in FIG. 3 and discussed hereinabove.

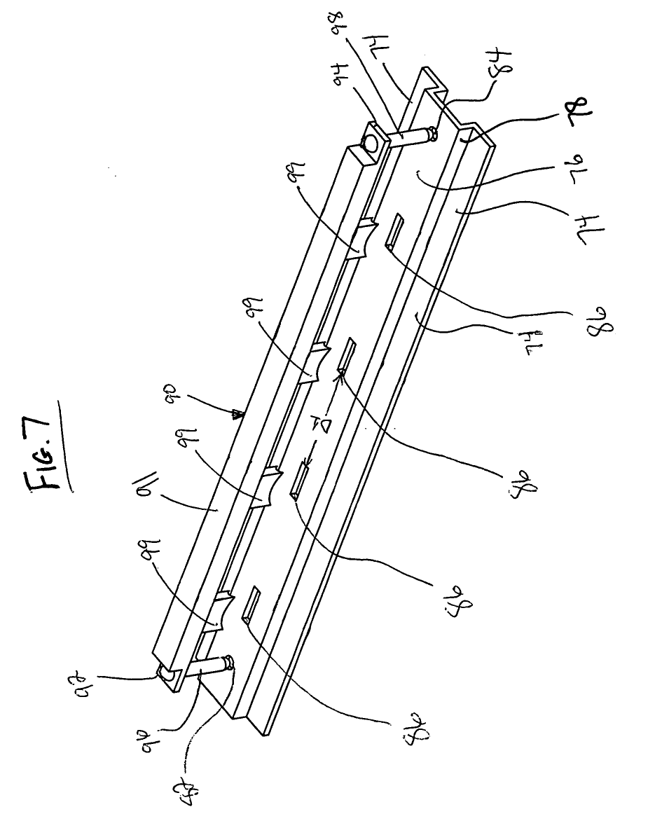

Step 104 provides a pre-configured punching die 90, which is illustrated in FIG. 7. The punching die 90 is formed from an elongated body 91 having a first end 92 and a second end 94. Proximate to the first end 92, the elongated body 91 has a guiding pin member 96 which extends through the elongated body 91 and, proximate to the second end 94, the elongated body 91 has a guiding pin member 98 which extends through the elongated body 91. The punching die 90 is pre-configured such that the guiding pin member 96 can be positioned within the aperture 82 of the post 44 and such that the guiding pin member 98 can be positioned within the aperture 84 of the post 44. The elongated body 91 is also pre-configured to have a plurality of shearing punches 99 provided between the guiding pin members 96, 98. Each shearing punch 99 protrudes from the elongated body 91 and is sized to correspond to the size of the slots 86 in the post 44. Each shearing punch 99 is distanced from an adjacent shearing punch 99 to correspond to the distance between adjacent slots 86 in the post 44.

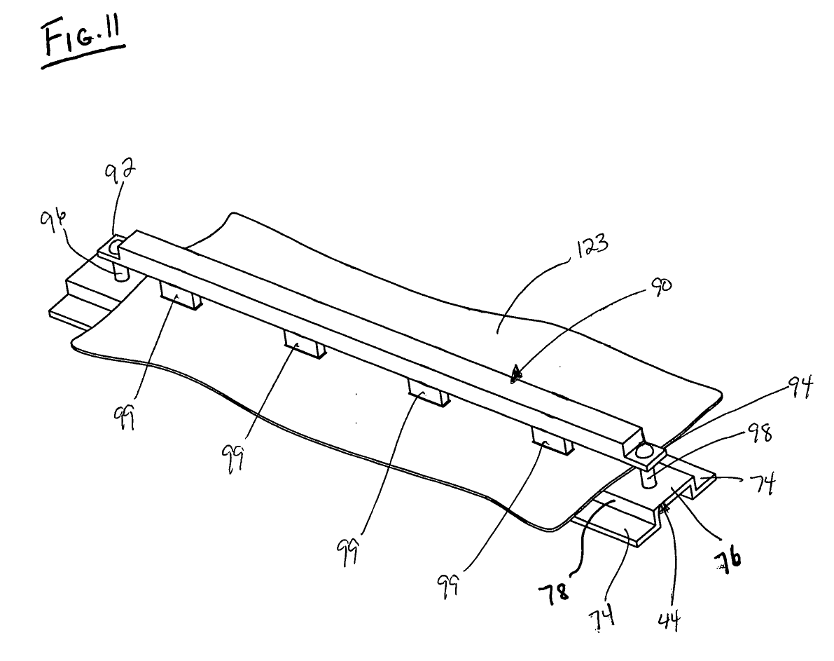

In step 118, an adhesive 119, which can be seen in FIG. 10, is preferably applied to the inner surface 78 of the intermediate portions 76 of each post 44 between where the apertures 82, 84 are provided, such that areas of the inner surface 78 of the intermediate portions 76 of each post 44 preferably do not have the adhesive 119 applied thereto, namely the top and bottom ends 54, 70 of the posts 44. When post 44a is utilized, the adhesive 119 would be applied to the inner surface 78a of at least one of the flat end portions 74a between where the apertures 82a, 84a are provided. When post 44b is utilized, the adhesive 119 would be applied to the inner surface 78b of the second flat end portion 77b between where the apertures 82b, 84b are provided.

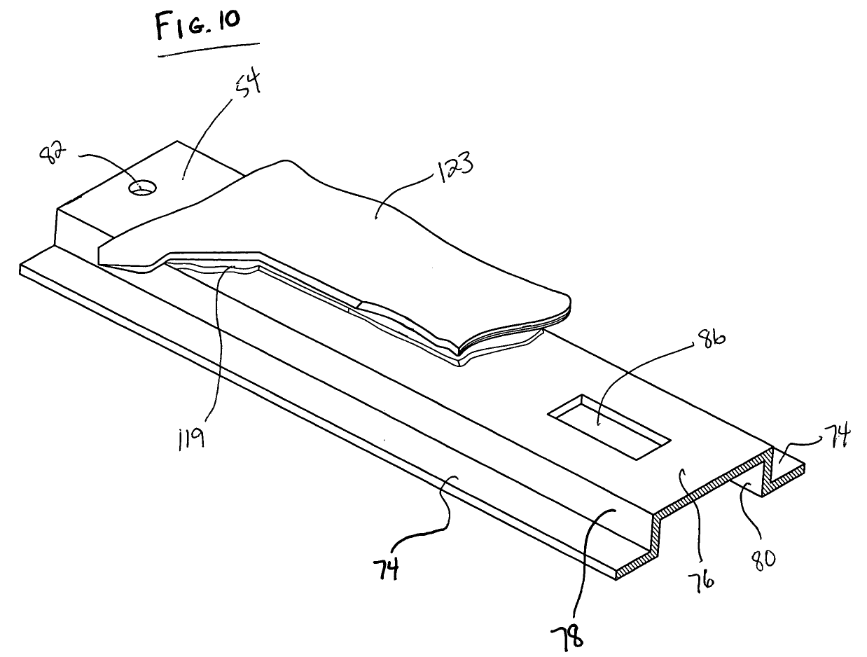

Step 121 secures a one-piece continuous liner 123 to the adhesive 119 applied to the intermediate portions 80 of the posts 44, as illustrated in FIGS. 9 and 10. The one-piece continuous liner 123 is preferably formed of a fiber reinforced plastic, such as a thermoplastic or thermoset glass reinforced material, or a metal, such as steel or aluminum, such that the one-piece continuous liner 123 is strong, but is also preferably a lightweight material.

The one-piece continuous liner 123 is preferably rectangular and extends from proximate to the top end 54 of each post 44 to proximate to the bottom end 70 of each post 44, such that it covers the adhesive 119 applied to the posts 44. The one-piece continuous liner 123 also preferably extends from the front wall 28 of the trailer 20 to the rear doors 30 of the trailer 20. Preferably, the one-piece continuous liner 123 is rolled out over the posts 44, beginning from either the end of the sidewall 126 proximate to the front wall 28 of the trailer 20, or from the end of the sidewall 126 proximate to the rear doors 30 of the trailer 20. Also, if desired, tension may be applied to one of the ends of the one-piece continuous liner 123 when the one-piece continuous liner 123 is rolled out over the posts 44 such that the one-piece continuous liner 123 is able to be relatively snag resistant and which, in addition, is able to absorb and deflect punishment without being scratched, punctured or otherwise defaced. Alternatively, the one-piece continuous liner 123 is placed down onto the posts 44.

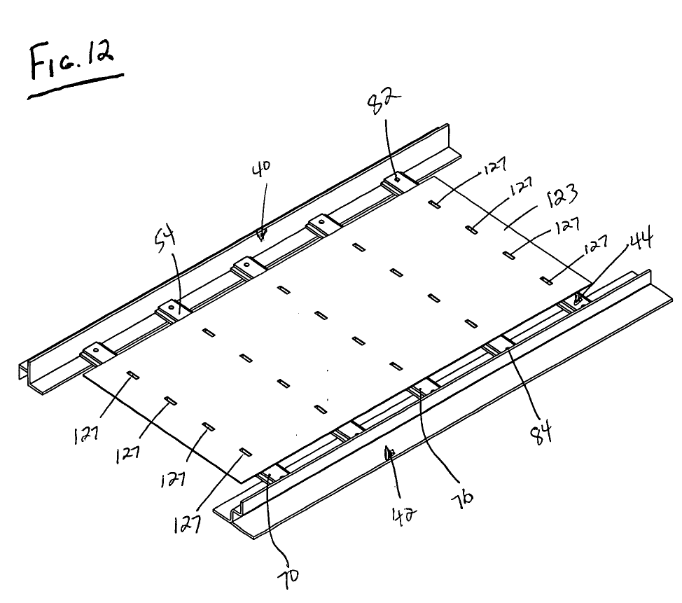

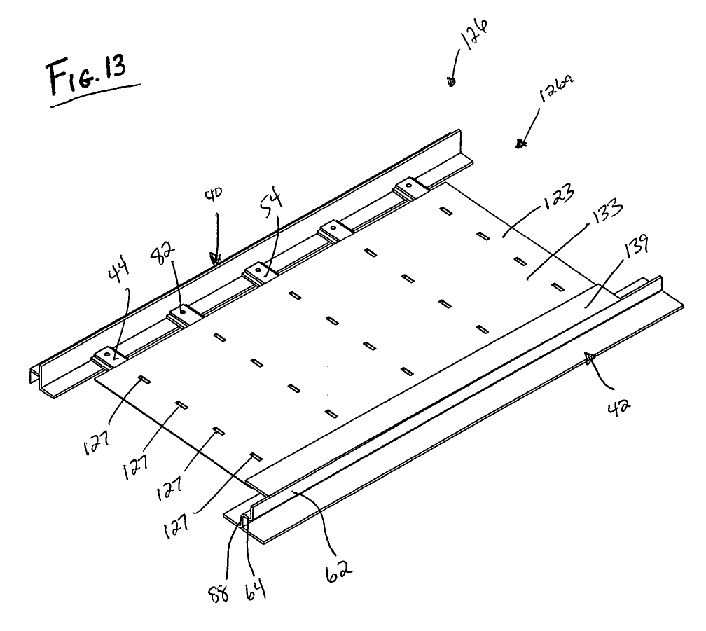

Step 125 uses the punching die 90 to punch slots 127 through the one-piece continuous liner 123 which are in communication with the slots 86 provided through the posts 44, as illustrated in FIG. 11. Step 125 is performed by first inserting the guiding pin member 96 into the aperture 82 of the post 44, and by inserting the guiding pin member 98 into the aperture 84 of the post 44. A force is then applied to the body 91 of the punching die 90 such that the shearing punches 99 are forced through the one-piece continuous liner 123 and into the slots 86 of the posts 44. The shearing punches 99 remove portions of the one-piece continuous liner 123 to provide the slots 127 through the one-piece continuous liner 123. The slots 127 are sized to be commensurate with the size of the slots 86, and the slots 127 are distanced from one another commensurate with the distance of the slots 86 from one another, as the punching die 90 is pre-configured in this manner. The slots 127 in the one-piece continuous liner 123 provide access to the slots 86 from an interior of the trailer 20 such that equipment can be engaged with the slots 86. Space is also provided behind the intermediate portion 80 of the posts 44 as the intermediate portion 80 bulges away from the flat end portions 74 further provides room within the sidewall configuration 126 such that equipment can be engaged with the slots 86 as part of the equipment would be positioned within the space provided behind the intermediate portion 80 of the posts 44. The punching die 90 is then removed from the one-piece continuous liner 123. Thus, the one-piece continuous liner 123 with the slots 127 punched therethrough is illustrated in FIG. 12.

Step 129 applies an adhesive 131, which can be seen in FIG. 14, to an inner surface 133 of the one-piece continuous liner 123 proximate to a bottom end 135 thereof and below the lowest slot 127, where the bottom end 135 of the one-piece continuous liner 123 is provided proximate to the aperture 84 of the post 44.

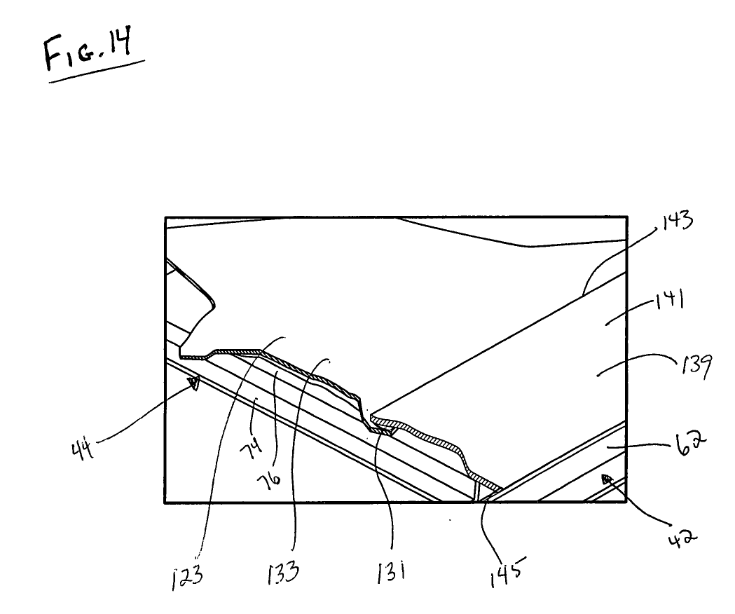

Step 137 secures a scuff plate 139 to the adhesive 131 applied to the inner surface 133 of the one-piece continuous liner 123, as illustrated in FIGS. 13 and 14. The scuff plate 139 is preferably a generally thin, elongated piece of metal or fiberglass which has an inner surface 141, an outer surface (not shown), a top end 143, and a bottom end 145, although other materials, such as wood, could be used to form the scuff plate 139. The outer surface of the scuff plate 139 proximate to the top end 143 thereof is secured to the adhesive 131 applied to the inner surface 133 of the one-piece continuous liner 123. The outer surface of the scuff plate 139 proximate to the bottom end 145 thereof is positioned against an inner surface 88 of the second portion 64 and the bottom end 145 of the scuff plate 139 is positioned proximate to, and preferably abuts against, a top surface (not shown) of the first portion 62. The scuff plate 139 may be secured to the bottom rail 42 by appropriate and known means, such as by fasteners, for instance rivets, or by adhesive, if desired.

The scuff plate 139 protects the sidewall 126 from damage, such as a forklift scratching or puncturing the sidewall 126. The scuff plate 139 may extend the length of the sidewall 126 from the front wall 28 to the rear doors 30, or the scuff plate 139 may be comprised of a plurality of pieces which are secured to one another by appropriate and known means, such as fasteners, for instance rivets, or adhesive.

It is to be understood that the one-piece continuous liner 123 need not be secured to each of the posts 44 comprising the frame 46, but that such a construction is preferred. The one-piece continuous liner 123 need only be secured to enough of the posts 44 comprising the frame 46 to ensure the stability of the one-piece continuous liner 123 on the frame 46. At a minimum, the one-piece continuous liner 123 is preferably secured to at least the post 44 which is positioned closest to the front wall 28 of the trailer 20 and to the post 44 which is positioned closest to the rear doors 30 of the trailer 20.

It is further to be understood that the method 100 of forming the inner wall 126a of the sidewall configuration 126 may be performed at any time during the construction of the trailer 20, and the steps of the method 100 may be performed in any order feasible.

Attention is directed to FIGS. 15-18 and the second embodiment of the inner wall 226a of the sidewall configuration 226 and the method 200 of forming same. A flow chart of the steps of the method 200 is illustrated in FIG. 15. The method 200 includes steps 202, 204, 225, 229 and 237, which are identical to respective steps 102, 104, 125, 129 and 137 of the method 100 and, therefore, are not repeated herein.

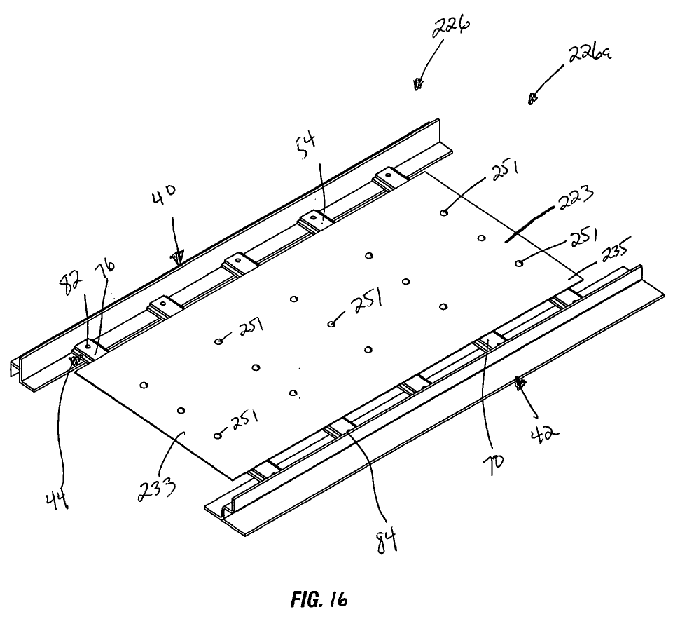

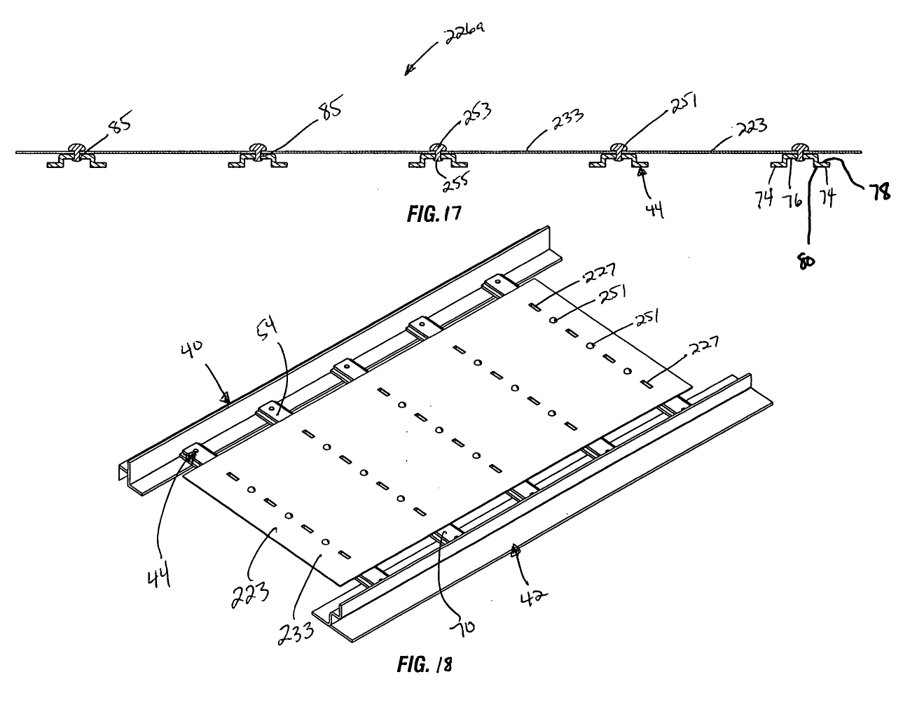

Step 247 positions a one-piece continuous liner 223 over the intermediate portions 80 of the posts 44, as illustrated in FIG. 16. The one-piece continuous liner 223 is preferably formed of a fiber reinforced plastic, such as a thermoplastic or thermoset glass reinforced material, or a metal, such as steel or aluminum, such that the one-piece continuous liner 223 is strong, but is also preferably a lightweight material.

The one-piece continuous liner 223 is preferably rectangular and extends from proximate to the top end 54 of each post 44 to proximate to the bottom end 70 of each post 44, such that it covers the inner surface 78 of the intermediate portions 76 of each post 44 between where the apertures 82, 84 are provided. When post 44a is utilized, the one-piece continuous liner 223 would cover the inner surface 78a of the flat end portions 74a between where the apertures 82a, 84a are provided. When post 44b is utilized, the one-piece continuous liner 223 would cover the inner surface 78b of the second flat end portion 77b between where the apertures 82b, 84b are provided.

The one-piece continuous liner 223 also preferably extends from the front wall 28 of the trailer 20 to the rear doors 30 of the trailer 20. Preferably, the one-piece continuous liner 223 is rolled out over the posts 44, beginning from either the end of the sidewall 226 proximate to the front wall 28 of the trailer 20, or from the end of the sidewall 226 proximate to the rear doors 30 of the trailer 20. Also, if desired, tension may be applied to one of the ends of the one-piece continuous liner 223 when the one-piece continuous liner 223 is rolled out over the posts 44 such that the one-piece continuous liner 223 is able to be relatively snag resistant and which, in addition, is able to absorb and deflect punishment without being scratched, punctured or otherwise defaced. Alternatively, the one-piece continuous liner 223 is placed down onto the posts 44.

Step 249 secures the one-piece continuous liner 223 to the intermediate portions 76 of each post 44 by a plurality of fasteners 251, such as rivets, as illustrated in FIGS. 16 and 17. A head portion 253 of each rivet 251 is positioned against an inner surface 233 of the one-piece continuous liner 223 and a shank portion 255 of each rivet 251 extends through the one-piece continuous liner 223 and through the intermediate portions 76 of each post 44, in order to secure the one-piece continuous liner 223 to the posts 44. The rivets 251 preferably extend through the intermediate portions 76 of each post 44 between where the slots 86 are provided in the post 44. Each post 44 may be pre-configured to have holes 85 therethrough through which the shank portions 255 of the rivets 251 would extend. When post 44a is utilized, the one-piece continuous liner 223 would be secured to at least one of the flat end portions 74a of each post 44a by a plurality of fasteners 251, such as rivets. When post 44b is utilized, the one-piece continuous liner 223 would be secured to the second flat end portion 77b of each post 44b by a plurality of fasteners 251, such as rivets.

It is to be understood that the one-piece continuous liner 223 need not be secured to each of the posts 44 comprising the frame 46, but that such a construction is preferred. The one-piece continuous liner 223 need only be secured to enough of the posts 44 comprising the frame 46 to ensure the stability of the one-piece continuous liner 223 on the frame 46. At a minimum, the one-piece continuous liner 223 is preferably secured to at least the post 44 which is positioned closest to the front wall 28 of the trailer 20 and to the post 44 which is positioned closest to the rear doors 30 of the trailer 20.

It is further to be understood that the method 200 of forming the inner wall 226a of the sidewall configuration 226 may be performed at any time during the construction of the trailer 20, and the steps of the method 200 may be performed in any order where feasible.

Attention is directed to FIGS. 19 and 20 and the third embodiment of the inner wall 326a of the sidewall configuration 326 and the method 300 of forming same. A flow chart of the steps of the method 300 is illustrated in FIG. 19. The method 300 includes the steps 302, 304, 318, 321, 325, 329 and 337, which are identical to respective steps 102, 104, 118, 121, 125, 129 and 137 of the method 100 and, therefore, are not repeated herein. The method 300 also includes the step 349 which is identical to respective step 249 of the method 200 and, therefore, is not repeated herein.

Thus, method 300 includes all of the steps of method 100, but also includes one of the steps of method 200, namely step 249 of securing the one-piece continuous liner 223 to the intermediate portions 76 of each post 44 by a plurality of fasteners 251, such as rivets. By securing the one-piece continuous liner 323 to the intermediate portions 76 of each post 44 by at least an adhesive 319 and/or by a plurality of fasteners 351, the method 300 provides a stronger securement of the one-piece continuous liner 323 to the intermediate portions 76 of each post 44 than do either of the methods 100, 200. Preferably, the one-piece continuous liner 323 is secured to each post 44 by the adhesive 319 and is further secured to the post 44 positioned closest to the front wall 28 of the trailer 20 and to the post 44 positioned closest to the rear doors 30 of the trailer 20, by the plurality of fasteners 351.

It is to be understood that the one-piece continuous liner 323 need not be secured to each of the posts 44 comprising the frame 46, but that such a construction is preferred. The one-piece continuous liner 323 need only be secured to enough of the posts 44 comprising the frame 46 to ensure the stability of the one-piece continuous liner 323 on the frame 46. At a minimum, the one-piece continuous liner 323 is preferably secured to at least the post 44 which is positioned closest to the front wall 28 of the trailer 20 and to the post 44 which is positioned closest to the rear doors 30 of the trailer 20.

It is to be understood that the method 300 of forming the inner wall 326a of the sidewall configuration 326 may be performed at any time during the construction of the trailer 20, and the steps of the method 300 may be performed in any order where feasible.

Attention is directed to FIGS. 21-24 and the fourth embodiment of the inner wall 426a of the sidewall configuration 426 and the method 400 of forming same. A flow chart of the steps of the method 400 is illustrated in FIG. 21. The method 400 includes steps 402, 404, 429 and 437, which are identical to respective steps 102, 104, 129 and 137 of the method 100 and, therefore, are not repeated herein.

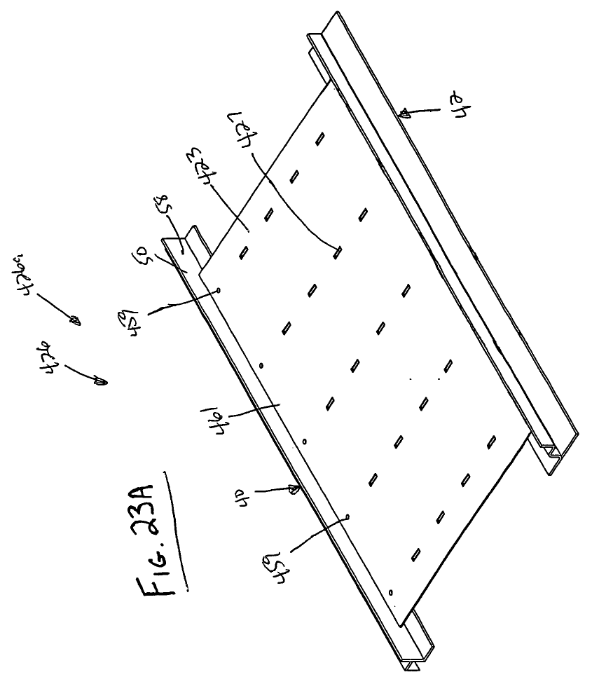

Step 457 provides a one-piece continuous liner 423 having a plurality of guide holes 459 provided proximate to a top end 461 of the one-piece continuous liner 423, as illustrated in FIG. 22. Each guide hole 459 is separated from an adjacent guide hole 459 by a predetermined distance D3. The one-piece continuous liner 423 is preferably formed of a fiber reinforced plastic, such as a thermoplastic or thermoset glass reinforced material, or a metal, such as steel or aluminum, such that the one-piece continuous liner 423 is strong, but is also preferably a lightweight material.

Step 467 uses the punching die 90 to punch slots 427 through the one-piece continuous liner 423. Step 467 is performed by first inserting the guiding pin member 96 into the guide hole 459 of the one-piece continuous liner 423. A force is then applied to the punching die 90 such that the shearing punches 99 are forced through the one-piece continuous liner 423, such that the shearing punches 427 remove portions of the one-piece continuous liner 423 to provide the slots 427 through the one-piece continuous liner 423. The slots 427 are sized to be commensurate with the size of the slots 86, and the slots 427 are distanced from one another to be commensurate with the distance of the slots 86 from one another, as the punching die 90 is pre-configured in this manner. The punching die 90 is then removed from the one-piece continuous liner 423. The one-piece continuous liner 423 having the slots 427 punched therethrough is illustrated in FIG. 22.

Step 469 preferably applies an adhesive 419 to the intermediate portions 76 of each post 44 from the top end 54 of the posts 44 to above where the aperture 84 of the post 44 is provided, such areas of the intermediate portions 76 of each post 44 preferably do not have the adhesive 419 applied thereto, namely at the bottom end 70 of the posts 44, similar to that as illustrated in FIGS. 9 and 10. When post 44a is utilized, the adhesive 419 would be applied to the inner surface 78a of at least one of the flat end portions 74a between where the apertures 82a, 84a are provided. When post 44b is utilized, the adhesive 419 would be applied to the inner surface 78b of the second flat end portion 77b between where the apertures 82b, 84b are provided.

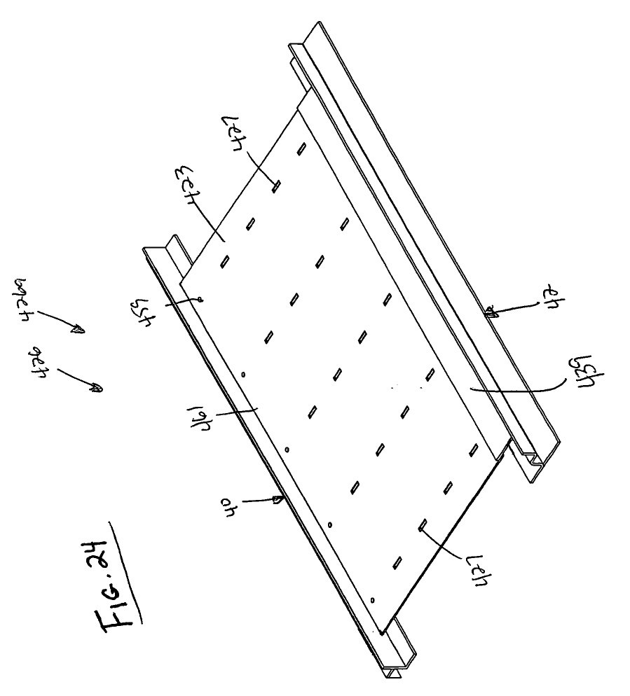

Step 471 secures the one-piece continuous liner 423 with the slots 427 punched therethrough to the adhesive 419 applied to the intermediate portions 76 of the posts 44, as illustrated in FIG. 23. When post 44a is utilized, the one-piece continuous liner 423 would be secured to the adhesive 419 applied to the at least one of the flat end portions 74a. When post 44b is utilized, the one-piece continuous liner 423 would be secured to the adhesive 419 applied to the second flat end portion 77b.

The one-piece continuous liner 423 is preferably rectangular and extends from the top end 54 of each post 44, such that the top end 461 of the one-piece continuous liner 423 is positioned proximate to, and preferably abuts against, the bottom surface 58 of the first flat portion 50 of the top rail 40, to proximate to the bottom end 70 of each post 44, such that is covers the adhesive 419 applied to the posts 44. If desired, the one-piece continuous liner 423 may be configured to extend to the bottom end 70 of each post 44, such that it covers the adhesive 419 applied to the posts 44 and such that it preferably abuts against the first horizontal flat portion 62 of the bottom rail 42, as illustrated in FIG. 23A. The one-piece continuous liner 423 also preferably extends from the front wall 28 of the trailer 20 to the rear doors 30 of the trailer 20. Preferably, the one-piece continuous liner 423 is rolled out over the posts 44, beginning from either the end of the sidewall 426 proximate to the front wall 28 of the trailer 20, or from the end of the sidewall 426 proximate to the rear doors 30 of the trailer 20. Also, if desired, tension may be applied to one of the ends of the one-piece continuous liner 423 when the one-piece continuous liner 423 is rolled out over the posts 44 such that the one-piece continuous liner 423 is able to be relatively snag resistant and which, in addition, is able to absorb and deflect punishment without being scratched, punctured or otherwise defaced. Alternatively, the one-piece continuous liner 423 is placed down onto the posts 44. Upon securing the one-piece continuous liner 423 to the adhesive 419 applied to the posts 44, the one-piece continuous liner 423 is positioned such that each of the slots 427 of the one-piece continuous liner 423 is positioned over one of the slots 86 of the posts 44, such that the slots 427 are in communication with the slots 86.

The slots 427 in the one-piece continuous liner 423 provide access to the slots 86 from an interior of the trailer 20 such that equipment can be engaged with the slots 86. Space is also provided behind the intermediate portion 76 of the posts 44 as the intermediate portion 76 bulges away from the flat end portions 74 further provides room within the sidewall configuration 426 such that equipment can be engaged with the slots 86 as part of the equipment would be positioned within the space provided behind the intermediate portion 76 of the posts 44.

It should be noted that if the one-piece continuous liner 423 is configured to extend to the bottom end 70 of the post 44 as illustrated in FIG. 23A, the scuff plate 439 is preferably formed from wood, preferably oak, rather than metal or fiberglass, and may be secured to the one-piece continuous liner 423 as previously described, or by any other suitable means.

It is to be understood that the one-piece continuous liner 423 need not be secured to each of the posts 44 comprising the frame 46, but that such a construction is preferred. The one-piece continuous liner 423 need only be secured to enough of the posts 44 comprising the frame 46 to ensure the stability of the one-piece continuous liner 423 on the frame 46. At a minimum, the one-piece continuous liner 423 is preferably secured to at least the post 44 which is positioned closest to the front wall 28 of the trailer 20 and to the post 44 which is positioned closest to the rear doors 30 of the trailer 20.

It is to be understood that the method 400 of forming the inner wall 426a of the sidewall configuration 426 may be performed at any time during the construction of the trailer 20, and the steps of the method 400 may be performed in any order where feasible.

Attention is directed to FIGS. 25 and 26 and the fifth embodiment of the inner wall 526a of the sidewall configuration 526 and the method 500 of forming same. A flow chart of the steps of the method 500 is illustrated in FIG. 25. The method 500 includes steps 502, 504, 529 and 537, which are identical to respective steps 102, 104, 129 and 137 of the method 100 and, therefore, are not repeated herein. The method 500 includes step 549, which is identical to respective step 249 of the method 200 and, therefore, is not repeated herein. The method 500 includes steps 557 and 567, which are identical to respective steps 457 and 467 of the method 400 and, therefore, are not repeated herein.

Step 573 positions the one-piece continuous liner 523 with the slots 527 punched therethrough over the intermediate portions 80 of the posts 44, as illustrated in FIG. 26. The one-piece continuous liner 523 is preferably formed of a fiber reinforced plastic, such as a thermoplastic or thermoset glass reinforced material, or a metal, such as steel or aluminum, such that the one-piece continuous liner 523 is strong, but it is also preferably a lightweight material.

The one-piece continuous liner 523 is preferably rectangular and extends from the top end 54 of each post 44, such that the top end 561 of the one-piece continuous liner 523 is positioned proximate to, and preferably abuts against, the bottom surface 58 of the first flat portion 50 of the top rail 40, to proximate to the bottom end 70 of each post 44. The one-piece continuous liner 523 also preferably extends from the front wall 28 of the trailer 20 to the rear doors 30 of the trailer 20. Preferably, the one-piece continuous liner 523 is rolled out over the posts 44, beginning from either the end of the sidewall 526 proximate to the front wall 28 of the trailer 20, or from the end of the sidewall 526 proximate to the rear doors 30 of the trailer 20. Also, if desired, tension may be applied to one of the ends of the one-piece continuous liner 523 when the one-piece continuous liner 523 is rolled out over the posts 44 such that the one-piece continuous liner 523 is able to be relatively snag resistant and which, in addition, is able to absorb and deflect punishment without being scratched, punctured or otherwise defaced. Alternatively, the one-piece continuous liner 523 is placed down onto the posts 44.

It should be noted that if the one-piece continuous liner 523 is configured to extend to the bottom end 70 of the post 44, the scuff plate 539 is preferably formed from wood, preferably oak, rather than metal or fiberglass, and may be secured to the one-piece continuous liner 523 as previously described, or by any other suitable means.

It is to be understood that the one-piece continuous liner 523 need not be secured to each of the posts 44 comprising the frame 46, but that such a construction is preferred. The one-piece continuous liner 523 need only be secured to enough of the posts 44 comprising the frame 46 to ensure the stability of the one-piece continuous liner 523 on the frame 46. At a minimum, the one-piece continuous liner 523 is preferably secured to at least the post 44 which is positioned closest to the front wall 28 of the trailer 20 and to the post 44 which is positioned closest to the rear doors 30 of the trailer 20.

It is to be understood that the method 500 of forming the inner wall 526a of the sidewall configuration 526 may be performed at any time during the construction of the trailer 20, and the steps of the method 500 may be performed in any order where feasible.

Attention is directed to FIG. 27 and the sixth embodiment of the inner wall 626a of the sidewall configuration 626 and the method 600 of forming same. A flow chart of the steps of the method 600 is illustrated in FIG. 27. The method 600 includes steps 602, 604, 629 and 637, which are identical to steps 102, 104, 129 and 137 of the method 100 and, therefore, are not repeated herein. The method 600 includes step 649 which is identical to step 249 of the method 200 and, therefore, is not repeated herein. The method 600 includes steps 657, 667, 669 and 671, which are identical to steps 457, 467, 469 and 471 and, therefore, are not repeated herein.

Thus, method 600 includes all of the steps of method 400, but also includes one of the steps of method 500, namely step 549 of securing the one-piece continuous liner 523 to the intermediate portions 76 of each post 44 by a plurality of fasteners 551, such as rivets. By securing the one-piece continuous liner 623 to the intermediate portions 76 of each post 44 by at least an adhesive 619 and/or by a plurality of fasteners 651, the method 600 provides a stronger securement of the one-piece continuous liner 623 to the intermediate portions 76 of each post 44 than do either of the methods 400, 500. Preferably, the one-piece continuous liner 623 is secured to each post 44 by the adhesive 619 and is further secured to the post 44 positioned closest to the front wall 28 of the trailer 20 and to the post 44 positioned closest to the rear doors 30 of the trailer 20, by the plurality of fasteners 651.

It is to be understood that the one-piece continuous liner 623 need not be secured to each of the posts 44 comprising the frame 46, but that such a construction is preferred. The one-piece continuous liner 623 need only be secured to enough of the posts 44 comprising the frame 46 to ensure the stability of the one-piece continuous liner 623 on the frame 46. At a minimum, the one-piece continuous liner 623 is preferably secured to at least the post 44 which is positioned closest to the front wall 28 of the trailer 20 and to the post 44 which is positioned closest to the rear doors 30 of the trailer 20.

It should be noted that if the one-piece continuous liner 623 is configured to extend to the bottom end 70 of the post 44, the scuff plate 639 is preferably formed from wood, preferably oak, rather than metal or fiberglass, and may be secured to the one-piece continuous liner 623 as previously described, or by any other suitable means.

It is to be understood that the method 600 of forming the inner wall 626a of the sidewall configuration 626 may be performed at any time during the construction of the trailer 20, and the steps of the method 300 may be performed in any order where feasible.

It should further be noted that in the preferred embodiment of each of the methods 100, 200, 300, 400, 500, 600, the liner 123, 223, 323, 423, 523, 623 is one-piece as illustrated and described, but the liner 123, 223, 323, 423, 523, 623, as illustrated in FIG. 9A with reference to liner 123 only, may be formed of a plurality of pieces 123a, 123b, but each piece 123a, 123b spans the distance between at least two adjacent posts 44.

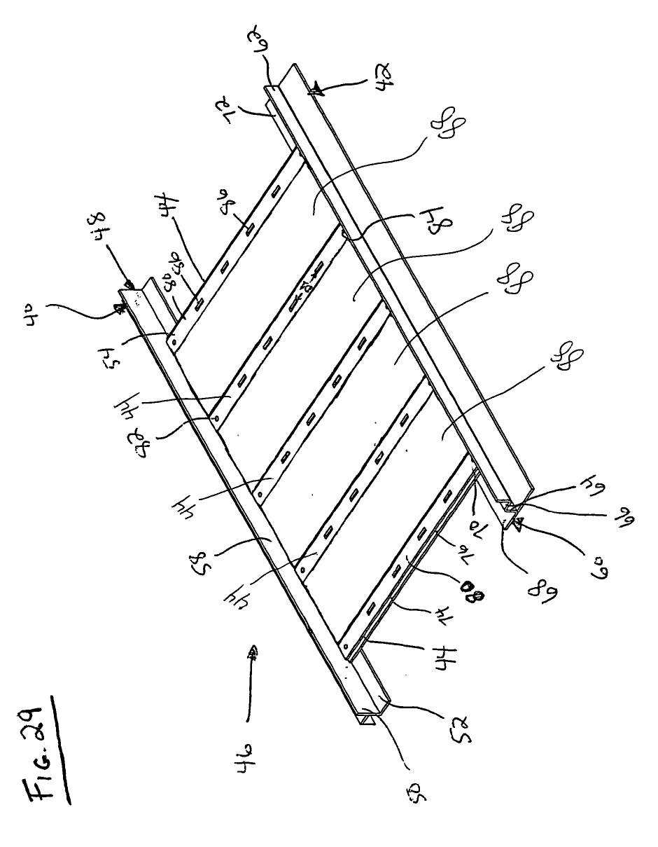

Each sidewall construction 126, 226, 326, 426, 526, 626 also preferably has an outer wall 26b, as illustrated in FIG. 28. As shown in the drawings, only a portion of the outer walls 26b is illustrated. It is to be understood that the outer wall 26b illustrated is generally provided for each sidewall 26 between the front wall 28 and the rear doors 30.

Outer wall 26b is formed of the plurality of the posts 44, adhesive 45, a plurality of panels 47, and a plurality of fasteners 49, such as rivets.

Each post 44 has the adhesive 45 provided along an outer surface 80 of the flat end portions 74 of the post 44.

Each panel 47 has an inner surface (not shown) and an outer surface 51. Each panel 47 further has a top edge 53, a bottom edge 55, a first side edge 57 and a second side edge 59. The inner surface of each panel 47 proximate to the first side edge 57 thereof is secured to one of the flat end portions 74 of one of the posts 44 by the adhesive 45. The inner surface of each panel 47 between the first and second side edges 57, 59 is secured to both of the flat end portions 74 of one of the posts 44 by the adhesive 45. The inner surface of each panel 47 proximate to the second side edge 59 thereof is positioned on top of the outer surface 51 of an adjacent panel 47 proximate to the first side edge 57 thereof.

The plurality of rivets 49 extend through the panel 47 proximate to the second side edge 59 thereof, through the adjacent panel 47 proximate to the first side edge 57 thereof, through the adhesive 45, and through the one flat end portion 74 of the post 44, in order to secure the panels 47 and the post 44 together, and such that a head portion 61 of the rivets 49 are positioned against the outer surface 51 of the panels 47 proximate to the second side edge 59 thereof.

It is to be understood that other configurations of outer walls could be utilized as desired.

Regardless of which embodiment 126a, 226a, 326a, 426a, 526a, 626a of the inner wall 26a of the sidewall construction 26 is used, an insulative material 88 may be provided between the inner wall 26a and the outer wall 26b and between adjacent posts 44, if desired. The insulative material 88 may be in the form of a foam panel, as illustrated in FIG. 29 or in any other form known in the art.

It should further be noted that, if desired, the posts 44 may be secured to only the top rail 40 and not the bottom rail 42, or may be secured to only the bottom rail 42 and not the top rail 40, or may be secured to neither the top rail 40 or the bottom rail 42, as the posts 44 will still be properly positioned within the sidewall 26 by the securement of the posts 44 to the inner wall 26a and/or the outer wall 26b.

While preferred embodiments of the invention are shown and described, it is envisioned that those skilled in the art may devise various modifications without departing from the spirit and scope of the foregoing description and the appended claims.

The invention is claimed as follows:

1. A sidewall configuration of a trailer comprising:
a plurality of spaced-apart posts, each said post having a plurality of slots provided therethrough;
an inner wall being comprised of a one-piece continuous liner secured to said plurality of posts, said one-piece continuous liner having a plurality of slots provided therethrough which are in communication with said plurality of slots provided through each said post.

2. A sidewall configuration as defined in claim 1, wherein each said post has a first portion and a second portion having said plurality of slots provided therethrough.

3. A sidewall configuration as defined in claim 2, wherein said first portion defines a pair of flat end portions, and wherein said second portion defines an intermediate portion which extends inwardly between said flat end portions such that each said post is generally U-shaped.

4. A sidewall configuration as defined in claim 2, wherein said second portion defines a pair of flat end portions, and wherein said first portion defines an intermediate portion which extends inwardly between said flat end portions such that each said post is generally U-shaped, said plurality of slots of each said post being associated with at least one of said flat end portions.

5. A sidewall configuration as defined in claim 2, wherein said first portion defines a first flat end portion, and wherein said second portion defines a second flat end portion, said first and second flat end portions being provided in different planes such that each said post is generally Z-shaped.

6. A sidewall configuration as defined in claim 2, wherein said one-piece continuous liner is secured to said second portion of at least two of said posts by an adhesive.

7. A sidewall configuration as defined in claim 6, wherein said one-piece continuous liner is secured to said second portion of each said post by said adhesive.

8. A sidewall configuration as defined in claim 2, wherein said one-piece continuous liner is secured to said second portion of at least two of said posts by a plurality of fasteners.

9. A sidewall configuration as defined in claim 8, wherein said one-piece continuous liner is secured to said second portion of each said post by said plurality of fasteners.

10. A sidewall configuration as defined in claim 2, wherein said one-piece continuous liner is secured to said second portion of at least two of said posts by a combination of an adhesive and a plurality of fasteners.

11. A sidewall configuration as defined in claim 10, wherein said one-piece continuous liner is secured to said second portion of each said post by said combination of said adhesive and said plurality of fasteners.

12. A sidewall configuration as defined in claim 2, further including an outer wall comprised of a plurality of panels, said panels are secured to said first portion of said posts, each said panel is secured to an adjacent panel.

13. A sidewall configuration as defined in claim 12, wherein said panels are secured to said first portion of said posts by an adhesive.

14. A sidewall configuration as defined in claim 12, wherein each said panel is secured to an adjacent panel by a plurality of fasteners.

15. A sidewall configuration as defined in claim 12, further including an insulative material provided between said inner and outer walls and between at least two of said posts.

16. A sidewall configuration as defined in claim 1, further including a bottom rail, and wherein a bottom end of said one-piece continuous liner generally extends to a position above said bottom rail.

17. A sidewall configuration as defined in claim 16, further including a top rail, and wherein a top end of said one-piece continuous liner generally extends to a position below said top rail.

18. A sidewall configuration as defined in claim 16, further including a top rail, and wherein a top end of said one-piece continuous liner generally extends to said top rail.

19. A sidewall configuration as defined in claim 16, wherein a scuff plate is secured to said bottom end of said one-piece continuous liner and generally extends to said bottom rail.

20. A sidewall configuration as defined in claim 19, wherein said scuff plate is formed of metal.

21. A sidewall configuration as defined in claim 19, wherein said scuff plate is secured to said bottom end of said one-piece continuous liner by an adhesive.

22. A sidewall configuration as defined in claim 1, further including a bottom rail, and wherein a bottom end of said one-piece continuous liner generally extends to said bottom rail.

23. A sidewall configuration as defined in claim 22, wherein a scuff plate is secured to said one-piece continuous liner proximate to said bottom end thereof and generally extends to said bottom rail.

24. A sidewall configuration as defined in claim 23, wherein said scuff plate is formed of wood.

25. A sidewall configuration as defined in claim 1, wherein said one-piece continuous liner is formed from a fiber reinforced plastic.

26. A sidewall configuration as defined in claim 1, wherein said one-piece continuous liner is formed from a metal.

27. A sidewall configuration as defined in claim 1, wherein said one-piece continuous liner is secured to said plurality of posts under tension.

28. A sidewall configuration of a trailer comprising:
a plurality of posts extending between said top rail and said bottom rail, each said post having a plurality of slots provided therethrough; and
an inner wall being comprised of at least one liner secured to said plurality of posts by an adhesive, said at least one liner having a plurality of slots provided therethrough which are in communication with said plurality of slots provided through each said post, said at least one liner configured to be secured to at least two of said plurality of posts.

29. A sidewall configuration as defined in claim 28, wherein said at least one liner is formed from a fiber reinforced plastic.

30. A sidewall configuration as defined in claim 28, wherein said at least one liner is formed from a metal.

31. A sidewall configuration as defined in claim 28, wherein said at least one liner is further secured to said plurality of posts by a plurality of fasteners.

32. A method of forming an inner wall of a sidewall configuration of a trailer, said method comprising the steps of:
a) providing a plurality of posts, each post having slots provided therethrough;
b) providing a pre-configured punching die;
c) securing a one-piece continuous liner to the plurality of posts; and
d) using said pre-configured punching die to punch slots through said one-piece continuous liner such that said slots through said one-piece continuous liner are configured to be in communication with said slots through said posts.

33. A method as defined in claim 32, further including the step of:
e) providing a bottom rail, a bottom end of said one-piece continuous liner extending to a position above said bottom rail; and
f) securing a scuff plate to an inner surface of said one-piece continuous liner such that said scuff plate generally extends to said bottom rail.

34. A method as defined in claim 33, wherein step (f) includes the sub-steps of:
f1) applying an adhesive to said inner surface of said one-piece continuous liner proximate to said bottom end thereof; and
f2) securing said scuff plate to said adhesive applied to said inner surface of said one-piece continuous liner.

35. A method as defined in claim 32, wherein in step (c), said one-piece continuous liner is secured to at least two of the plurality of posts by an adhesive.

36. A method as defined in claim 35, wherein in step (c), said one-piece continuous liner is rolled out over the plurality of posts.

37. A method as defined in claim 36, wherein in step (c), said one-piece continuous liner 5 is rolled out over the plurality of posts under tension.

38. A method as defined in claim 32, wherein in step (c), said one-piece continuous liner is secured to at least two of the plurality of posts by a plurality of fasteners.

39. A method as defined in claim 38, wherein in step (c), said one-piece continuous liner is rolled out over the plurality of posts.

40. A method as defined in claim 39, wherein in step (c), said one-piece continuous liner is rolled out over the plurality of posts under tension.

41. A method as defined in claim 32, wherein in step (c), said one-piece continuous liner is secured to at least two of the plurality of posts by a combination of an adhesive and a plurality of fasteners.

42. A method as defined in claim 41, wherein in step (c), said one-piece continuous liner is rolled out over the plurality of posts.

43. A method as defined in claim 42, wherein in step (c), said one-piece continuous liner is rolled out over the plurality of posts under tension.

44. A method as defined in claim 32, wherein each said post has an opening provided proximate to a top end thereof and proximate to a bottom end thereof, and wherein said pre-configured punching die has a guiding pin member proximate to a top end thereof and proximate to a bottom end thereof, and wherein said pre-configured punching die has a plurality of shearing punches provided between said guiding pin members, wherein each shearing punch is sized and distanced from one another commensurate with a size and distance of said slots of each said post.

45. A method as defined in claim 44, wherein step (c) is performed before step (d); and
wherein step (d) further includes the sub-steps of:
d1) inserting the guiding pin members into said openings proximate to said top and bottom ends of said post;
d2) applying a force to said pre-configured punching die such that said shearing punches are forced through said one-piece continuous liner and into said slots of said posts in order to provide slots through said one-piece continuous liner which are in communication with said slots of said posts; and
d3) removing said pre-configured punching die from said one-piece continuous liner.

46. A method as defined in claim 44, wherein step (d) is performed before step (c); and
wherein said one-piece continuous liner is provided with a plurality of apertures proximate to a top end thereof and proximate to a bottom end thereof, and wherein step (d) further includes the sub-steps of:
d1) inserting the guiding pin members into said openings proximate to said top and bottom ends of said one-piece continuous liner;
d2) applying a force to said pre-configured punching die such that said shearing punches are forced through said one-piece continuous liner in order to provide slots through said one-piece continuous liner which are configured to be in communication with said slots of said posts during step (c); and
d3) removing said pre-configured punching die from said one-piece continuous liner.
